(19) United States
(12) Patent Application Publication
(10) Pub. No.: US 2016/0205189 A1
(43) Pub. Date: Jul. 14, 2016

(54) PROACTIVE MONITORING AND DIAGNOSTICS IN STORAGE AREA NETWORKS

(71) Applicant: HEWLETT PACKARD ENTERPRISE DEVELOPMENT LP, Houston, TX (US)

(72) Inventors: SATISH KUMAR MOPUR, Bangalore (IN); Sumantha Kannantha, Bangalore (IN); Shreyas Majithia, Bangalore (IN); Akilesh Kailash, Bangalore (IN); Aesha Dhar Roy, Bangalore (IN); Satyaprakash Rao, Littleton, MA (US); Krishna Puttagunta, Roseville, CA (US); Chuan Peng, Houston, TX (US); Prakash Hosahally Suryanarayana, Bangalore (IN); Sudha Ramakrishnaiah, Bangalore (IN); Ranganath Prabhu VV, Bangalore (IN)

(21) Appl. No.: 14/911,719

(22) PCT Filed: Aug. 15, 2013
(86) PCT No.: PCT/US2013/055216

§ 371 Date: Feb. 11, 2016

(51) Int. Cl. H04L 29/08; H04L 12/26; G06F 17/30

(52) U.S. Cl. CPC H04L 67/1097; G06F 17/30958; H04L 43/16

(57) ABSTRACT

The present subject matter relates to perform proactive monitoring and diagnostics in storage area networks (SANs). In one implementation, the method comprises depicting topology of the SAN in a graph, wherein the graph designates the devices as nodes, the connecting elements as edges, and depicts operations associated with at least one component of the nodes and edges. The method further comprises monitoring at least one parameter indicative of performance of the component to ascertain degradation of the at least one component and identifying, a hinge in the data associated with the monitoring, wherein the hinge is indicative of an initiation in degradation of the component. Based on the hinge, proactive diagnostics is preformed to compute a remaining lifetime of the at least one component. Thereafter, a notification is generated for an administrator of the SAN based on the remaining lifetime.

### BACKGROUND

Generally, communication networks may comprise a number of computing systems, such as servers, desktops, and laptops. The computing systems may have various storage devices directly attached to the computing systems to facilitate storage of data and installation of applications. In case of any failure in the operation of the computing systems, recovery of the computing systems to a fully functional state may be time consuming as the recovery would involve reinstallation of applications, transfer of data from one storage device to another storage device and so on. To reduce the downtime of the applications affected due to the failure in the computing systems, storage area networks (SANs) are used.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the figures to reference like features and components:

FIG. 1a schematically illustrates a proactive monitoring and diagnostics system, according to an example of the present subject matter.

FIG. 1b schematically illustrates the components of the proactive monitoring and diagnostics system, according to another example of the present subject matter.

FIG. 2 illustrates a graph depicting a topology of a storage area network (SAN) for performing proactive monitoring and diagnostics in the SAN, according to an example of the present subject matter.

FIG. 3a illustrates a method for performing proactive monitoring and diagnostics in the SAN, according to another example of the present subject matter.

FIGS. 3b and 3c illustrate a method for performing proactive monitoring and diagnostics in the SAN, according to another example of the present subject matter.

FIG. 4 illustrates a computer readable medium storing instructions for performing proactive monitoring and diagnostics in the SAN, according to an example of the present subject matter.

### DETAILED DESCRIPTION

SANs are dedicated networks that provide access to consolidated, block level data storage. In SANs, the storage devices, such as disk arrays, tape libraries, and optical jukeboxes, appear to be locally attached to the computing systems rather than connected to the computing systems over a communication network. Thus, in SANs, the storage devices are communicatively coupled with the SANs instead of being attached to individual computing systems.

SANs make relocation of individual computing systems easier as the storage devices may not have to be relocated. Further, upgrade of storage devices may also be easier as individual computing systems may not have to be upgraded. Further, in case of failure of a computing system, downtime of affected applications is reduced as a new computing system may be setup without having to perform data recovery and/or data transfer.

SANs are generally used in data centers, with multiple servers, for providing high data availability, ease in terms of scalability of storage, efficient disaster recovery in failure situations, and good input-output (I/O) performance.

The present technique relate to systems and methods for proactive monitoring and diagnostics in storage area networks (SANs). The methods and the systems as described herein may be implemented using various computing systems.

In the current business environment, there is an ever increasing demand for storage of data. Many data centers use SANs to reduce downtime due to failure of computing systems and provide users with high input-output (I/O) performance and continuous accessibility to data stored in the storage devices connected to the SANs. In SANs, different kinds of storage devices may be interconnected with each other and to various computing systems. Generally, a number of components, such as switches and cables, are used to connect the computing systems with the storage devices in the SANs. In a medium-sized SAN, the number of components which facilitate connection between the computing systems and storage devices may be in the range of thousands. A SAN may also include other components, such as transceivers, also known as Small Form-Factor Pluggable modules (SFPs). These other components usually interconnect the Host Bus Adapters (HBAs) of the computing systems with switches and storage ports. HBAs are those components of computing systems which facilitate I/O processing and connect the computing systems with storage ports and switches over various protocols, such as, small computer system interface (SCSI) and serial advanced technology attachment (SATA).

Generally, with time, there is degradation in these components which reduces their performance. Any change in parameters, such as transmitted power, gain and attenuation, of the components which adversely affects the performance of the components may be referred to as degradation. Degradation of one or more components in the SANs may reduce the performance of the SANs. For example, degradation may result in a reduced data transfer rate or a higher response time.

Further, different types of components may degrade at different rates and thus can have different life times. For example, cables may have a life time of two years, whereas switches may have a life time of five years. Since a SAN comprises various types of components and a large number of the various types of components, identifying those components whose degradation may potentially cause failure of the SAN or may adversely affect the performance of the SAN is a challenging task. If the degraded components are not replaced in a timely manner, the same may potentially cause failure and result in an unplanned downtime or reduce the performance of the SANs.

The systems and the methods, described herein, implement proactive monitoring and diagnostics in SANs. In one example, the method of proactive monitoring and diagnostics in SANs is implemented using a proactive monitoring and diagnostics (PMD) system. The PMD system may be implemented by any computing system, such as personal computers and servers.

In one example, the PMD system may determine a topology of the SAN and generate a four-layered graph representing the topology of the SAN. In said example, the PMD system may discover devices, such as switches, HBAs and storage devices with SFP Modules in the SAN, and designate the same as nodes. The PMD system may use various techniques, such as telnet, simple network management protocol (SNMP), internet control message protocol (ICMP), scanning of internet protocol (IP) address and scanning media access control (MAC) address, to discover the devices. The PMD system may also detect the connecting elements, such as cables and interconnecting transceivers, between the discovered devices and designate the detected connecting elements as edges. Thereafter, the PMD system may generate a first layer of the graph depicting the nodes and the edges where nodes represent devices which may have ports for interconnection with other devices. Examples of such devices include HBAs, switches and storage devices. The ports of the devices designated as nodes may be referred to as node ports. In the first layer, the edges represent connections between the node ports. For the sake of simplicity it may be stated that edges represent connection between devices.

The PMD system may then generate the second layer of the graph. The second layer of the graph may depict the components of the nodes and edges, for example, SFP modules and cables, respectively. The second layer of the graph may also indicate physical connectivity infrastructure of the SAN. In one example, the physical connectivity infrastructure comprises the connecting elements, such as the SFP modules and the cables, that interconnect the components of the nodes.

The PMD system then generates the third layer of the graph. The third layer depicts the parameters that are indicative of the performance of the components, depicted in the second layer. These parameters that are associated with the performance of the components may be provided by an administrator of the SAN or by a manufacturer of each component. For example, performance of the components of the nodes, such as switches, may be dependent on parameters of SFP modules in the node ports, such as received power, transmitted power and temperature parameters. Similarly, one of the parameters on which the working or the performance of a cable between two switches is dependent may include attenuation factor of the cable.

Thereafter, the PMD system generates the fourth layer of the graph which indicates operations that are to be performed based on the parameters. In one example, the fourth layer may be generated based on the type of the component and the parameters associated with the component. For instance, if the component is a SFP and the parameters associated with the SFP are transmitted power, received power, temperature, supply voltage and transmitted bias, the operation may include testing whether each of these parameter lie within a predefined normal working range. The operations associated with each component may be defined by the administrator of the SAN or by the manufacturer of each component.

The operations may be classified as local node operations and cross node operations. The local node operations may be the operations performed on parameters of a node and an edge which affect the working of the node or the edge. The cross node operations may be the operations that are performed based on the parameters of interconnected nodes.

As explained above, the graph depicting the components and their interconnections as nodes and edges, along with parameters indicative of performance of the components is generated. Based on the generated graph, the PMD system identifies the parameters indicative of performance of the components. Examples of such parameters of a component, such as a SFP module, may be transmitted power, received power, temperature, supply voltage and transmitted bias. The PMD system then monitors the identified parameters to determine degradation in the performance of the components of nodes and edges, In one example, the PMD system may read values of the parameters from sensors associated with the components. In another example, the PMD system may include sensors to measure the values of the parameters associated with the components.

The PMD system monitors the identified parameters over a period of time and determines a trend in the data associated with the monitoring for identifying a hinge in the data. A hinge may be understood as a point in the trend of the data that is an initiation in degradation of the component. The hinge may also occur due to degradation in performance of another component coupled to the component being monitored. Based on the hinge, the PMD system may perform proactive diagnostics. In proactive diagnostics, the PMD system carries out one or more operations that are defined in the fourth layer of the graph and further predicts a remaining lifetime of the component being monitored. Remaining lifetime of a component may be understood as the time in which the component would fail or completely degrade. Similarly, if the hinge is caused due to degradation of another component, the PMD system may predict a remaining lifetime of the another component in a similar manner as described in context of the component being monitored.

The PMD system may also perform “what-if” analysis to determine the impact of the potential failure or potential degradation of the component on the functioning and/or performance of the SAN, based on the generated graph.

The techniques of proactive monitoring and diagnostics are explained with the help of a SFP module. However, the same techniques will be applicable for other components of the SAN as well. In one example, the SFP module may degrade, i.e., work with reduced performance over a period of time, and may finally fail or not work at all. In operation, the PMD system may monitor the parameters associated with the SFP module as depicted in the third layer of the graph. Examples of such parameters may include received power, transmitted power and bias. In one example, the PMD system may smoothen the data associated with the monitoring, i.e., various values of the parameters that would have been read by the PMD system over a period of time. For example, the PMD system may implement techniques, such as moving average technique, to smoothen minor oscillations in the data. In one example, the PMD system may implement the moving average technique using one or more finite impulse response (FIR) filter(s) to analyze a set of data points, of the data, by computing a series of averages of different subsets of the full data.

The PMD system may also determine the trend of the data generated by monitoring the parameters, using techniques, such as segmented linear regression. In one example, using segmented linear regression, the PMD system may determine the relationship between a scalar dependent variable, in this case a parameter of a component, and one or more explanatory variables, in this case another parameter(s) of the component or elapsed time period post installation of the component. In the example of the SFP module considered above, the PMD system may determine the relationship between a parameter, such as power transmitted by the SFP module, and time elapsed after installation of the SFP module. Based on the relationship, the PMD system may predict the time interval in which the SFP module may degrade or fail.

In one example, the relationship between the parameter and the elapsed time may be depicted as a plot. In said example, the plot may be broken into a plurality of segments of equal segment size. For example, a first segment may be the portion of the plot generated based on the values of the parameter measured between × units of time and 2× units of time. Similarly, a second segment, having the same segment size as that of the first segment, may be the portion of the plot generated based on the values of the parameter measured between 2× units of time and 3× units of time.

In one example, the segment size, used for segmented linear regression, may be varied by the administrator of the SAN based on the parameter of the component and the degradation stage of the component. Further, the PMD system may implement segmented regression and compute slope of each of the segments, formed based on the values of the monitored parameters in a given segment. The slope of a segment indicates the rate of change of the values of the monitored parameters with respect to elapsed time. The slopes of the segments may be used to determine the hinge in the smoothened data. The hinge may be indicative of start of degradation of the SFP module or may indicate degradation in the performance of the SFP module owing to degradation in a connected component. In one example, the hinge may refer to a connecting point of two data sets which have different trends, for example, where the slope changes by more than a minimum value. Further, the PMD system may determine the connecting point with greater than the minimum value of change in slope to be a hinge based on consecutive negative changes in the slopes of successive segments of the smoothened data.

In one example, the PMD system may further enhance the precision with which the hinge is determined based on the smoothened data. In said example, the PMD system may determine goodness of fit of regression for the plot depicting the relationship between a parameter and the elapsed time. The goodness of fit of regression, also referred to as a coefficient of determination, indicates how well the measured values of the parameters fit standard statistical models. In one example, the PMD system may identify values of goodness of fit, which are less than a pre-defined threshold. A low value of goodness of fit may be associated with consecutive changes in slope of segments of the plot. This helps the PMD system to determine a precise hinge.

In one example, the PMD system may further enhance the accuracy with which the hinge is determined. In said example, the PMD system may also filter out rapid fall or rise in the monitored data. In one example, the data associated with the rise and/or fall in the monitored data may be filtered out. In another example, regression error residual values present in the smoothened data may be monitored. A regression error residual value is indicative of the extent of a deviation of a value of the monitored parameter from an expected value of the monitored parameter. Toggling of regression error residual values about a normal reference value is indicative of a sudden rise or fall in the value of the monitored parameter. The data associated with the toggled regression error residual values are filtered out. The data associated with sudden rise and/or fall, i.e., steep slopes, may not be considered for proactive diagnostics as such data is not indicative of degradation of a component. Removal of data associated with spikes and data associated with the regression error residual values from the smoothened data enhances the accuracy with which the hinge is determined.

Thereafter, the PMD system may also perform proactive diagnostics based on the hinge, wherein the proactive diagnostics comprise the one or more operations. For explanation, refer to the example of the SFP module considered above. As mentioned above, the identified hinge may be indicative of start of degradation of the SFP module or may indicate a degradation in the performance of the SFP module owing to a degradation in a connected component. The operations performed in proactive diagnostics identify whether the SFP module or a connected component is degrading. On identifying that the SFP module is degrading, further step of proactive diagnostics are performed to predict a remaining lifetime for the SFP module. Similarly, on identifying that the connected component is degrading, a remaining lifetime for the connected component may be predicted,

To predict a remaining lifetime of a component, in one example, the PMD system analyzes the filtered data to determine the rate of degradation of the component, The PMD system may also generate alarms when, due to the degradation in a component, the performance of the SAN may fall below a pre-defined performance threshold.

The proactive monitoring and diagnostics of a component, in one example, may be continued till the component is replaced by a new component. The PMD system then starts proactive monitoring and diagnostics of the new component.

The system and method for performing proactive monitoring and diagnostics in a SAN involve generation of the graph depicting the topology of the SAN, which facilitates easy identification of the degraded component even when the same is connected to multiple other components. Further, the system and method of proactive monitoring and diagnostics predict remaining lifetime of a component and generate notifications for the administrator, which help the administrator to determine the time at which the component is to be replaced. This facilitates timely replacement of components which have degraded or have malfunctioned and help in continuous operation of the SAN.

The above systems and the methods are further described in conjunction with the following figures. It should be noted that the description and figures merely illustrate the principles of the present subject matter. Further, various arrangements may be devised that, although not explicitly described or shown herein, embody the principles of the present subject matter and are included within its spirit and scope.

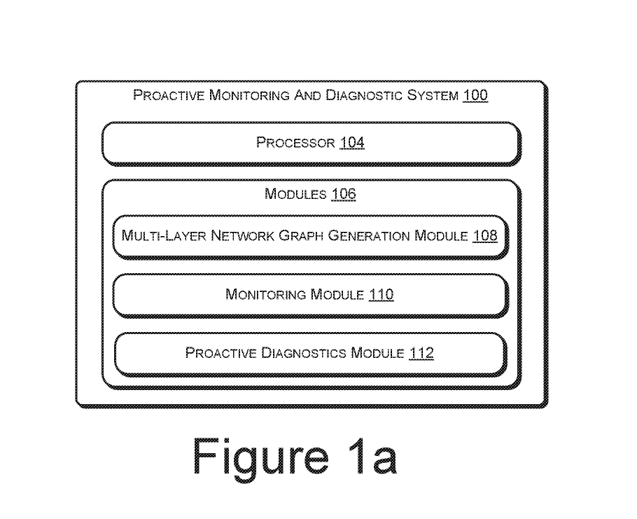

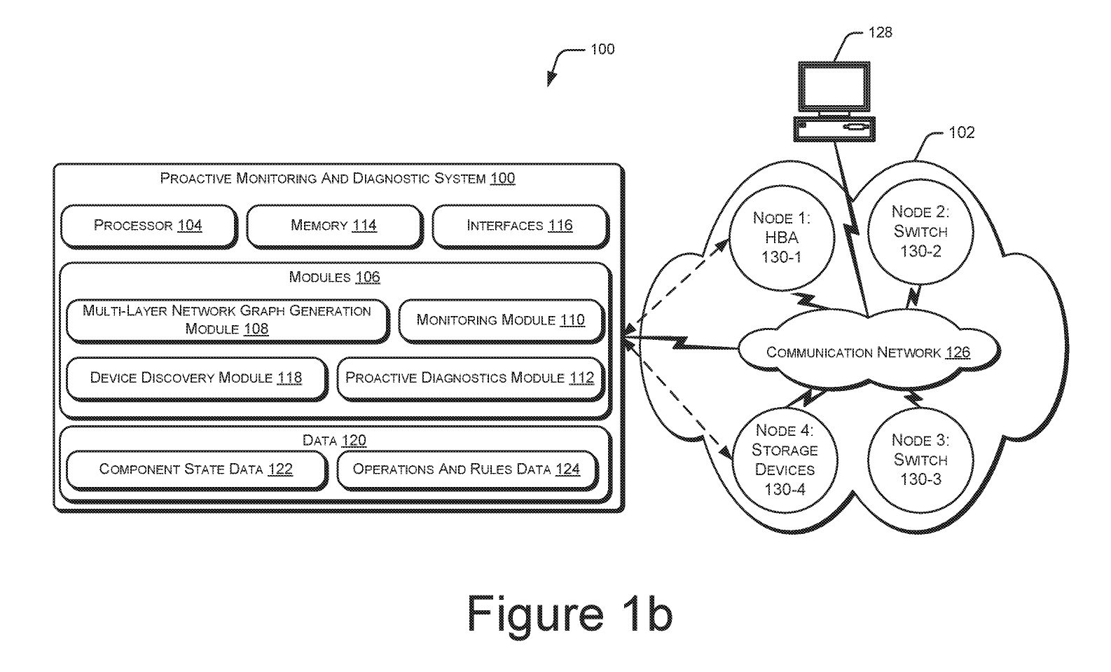

The manner in which the systems and methods for proactive monitoring and diagnostics of a storage area network are implemented are explained in details with respect to FIGS. 1a, 1b, 2, 3a, 3b, 3c, and 4. While aspects of described systems and methods for proactive monitoring and diagnostics of a storage area network can be implemented in any number of different computing systems, environments, and/or implementations, the examples and implementations are described in the context of the following system(s).

FIG. 1a schematically illustrates a proactive monitoring and diagnostics (PMD) system 100 for performing proactive diagnostics in a storage area network (SAN) 102 (shown in FIG. 1b), according to an example of the present subject matter. In one example, the PMD system 100 may be implemented as any computing system.

In one implementation, the PMD system 100 includes a processor 104 and modules 106 communicatively coupled to the processor 104. The modules 106, amongst other things, include routines, programs, objects, components, and data structures, which perform particular tasks or implement particular abstract data types. The modules 106 may also be implemented as signal processor(s), state machine(s), logic circuitries, and/or any other device or component that manipulates signals based on operational instructions. Further, the modules 106 can be implemented by hardware, by computer-readable instructions executed by a processing unit, or by a combination thereof. In one implementation, the modules 106 include a multi-layer network graph generation (MLNGG) module 108, a monitoring module 110 and a proactive diagnostics module 112.

In one example, the MLNGG module 108 generates a graph representing a topology of the SAN. The graph comprises nodes indicative of devices in the SAN, edges indicative of connecting elements between the devices, and one or more operations associated with at least one component of the nodes and edges. The monitoring module 110 monitors at least one parameter indicative of performance of the at least one component,

The proactive diagnostics module 112 then determines a trend in the data associated with the monitoring for identifying a hinge in the data, wherein the hinge is indicative of an initiation in degradation of the at least one component. Thereafter, the proactive diagnostics module 112 performs proactive diagnostics based on the identification of the hinge, wherein the proactive diagnostics comprise the one or more operations defined in the graph representing the topology of the SAN. The proactive diagnostics performed by the PMD system 100 is described in detail in conjunction with FIG. 1b.

FIG. 1b schematically illustrates the various constituents of the PMD system 100 for performing proactive diagnostics in the SAN 102, according to another example of the present subject matter, The PMD system 100 may be implemented in various computing systems, such as personal computers, servers and network servers.

In one implementation, the PMD system 100 includes the processor 104, and a memory 114 connected to the processor 104. Among other capabilities, the processor 104 may fetch and execute computer-readable instructions stored in the memory 114.

The memory 114 may be communicatively coupled to the processor 104. The memory 114 can include any commercially available non-transitory computer-readable medium including, for example, volatile memory, and/or non-volatile memory.

Further, the PMD system 100 includes various interfaces 116. The interfaces 116 may include a variety of commercially available interfaces, for example, interfaces for peripheral device(s), such as data input and output devices, referred to as I/O devices, storage devices, and network devices. The interfaces 116 facilitate the communication of the PMD system 100 with various communication and computing devices and various communication networks,

Further, the PMD system 100 may include the modules 106. In said implementation, the modules 106 include the MLNGG module 108, the monitoring module 110, a device discovery module 118 and the proactive diagnostics module 112. The modules 106 may also include other modules (not shown in the figure). These other modules may include programs or coded instructions that supplement applications or functions performed by the PMD system 100. The interfaces 116 also facilitate the PMD system 100 to interact with HBAs and interfaces of storage devices for various purposes, such as for performing proactive monitoring and diagnostics.

In an example, the PMD system 100 includes data 120. In said example, the data 120 may include component state data 122, operations and rules data 124 and other data (not shown in figure). The other data may include data generated and saved by the modules 106 for providing various functionalities of the PMD system 100.

In one implementation, the PMD system 100 may be communicatively coupled to various devices or nodes of the SAN over a communication network 126. Examples of devices which may be connected to the PMD system 100, as depicted in FIG. 1b, may be a nodel , representing a HBA 130-1, a node2, representing a switch 130-2, a node 3, representing a switch 130-3, and a node4, representing storage devices 130-4. The PMD system 100 may also be communicatively coupled to various client devices 128, which may be implemented as personal computers, workstations, laptops, netbook, smart-phones and so on, over the communication network 126. The client devices 128 may be used by an administrator of the SAN 102 to perform various operations,

The communication network 126 may include networks based on various protocols, such as Gigabit Ethernet, Synchronous Optical Networking (SONET), Fiber Channel network, or any other communication network that uses any of the commonly used protocols, for example, Hypertext Transfer Protocol (HTTP) and Transmission Control Protocol/Internet Protocol (TCP/IP),

In operation, the device discovery module 118 may use various mechanisms, such as Simple Network Management Protocol (SNMP), Web Service (WS) discovery, Low End Customer device Model (LEDM), bonjour, Lightweight Directory Access Protocol (LDAP)-walkthrough to discover the various devices connected to the SAN 102. As mentioned before, the devices are designated as nodes 130. Each node 130 may be uniquely identified by a unique node identifier, such as the MAC address of the node or the IP address of the node 130, or serial number, in case the node 130 is a SFP module. The device discovery module 118 may also discover the connecting elements, such as cables, as edges between two nodes 130. In one example, each connecting element may be uniquely identified by the port numbers of the nodes 130 at which the connecting element terminates.

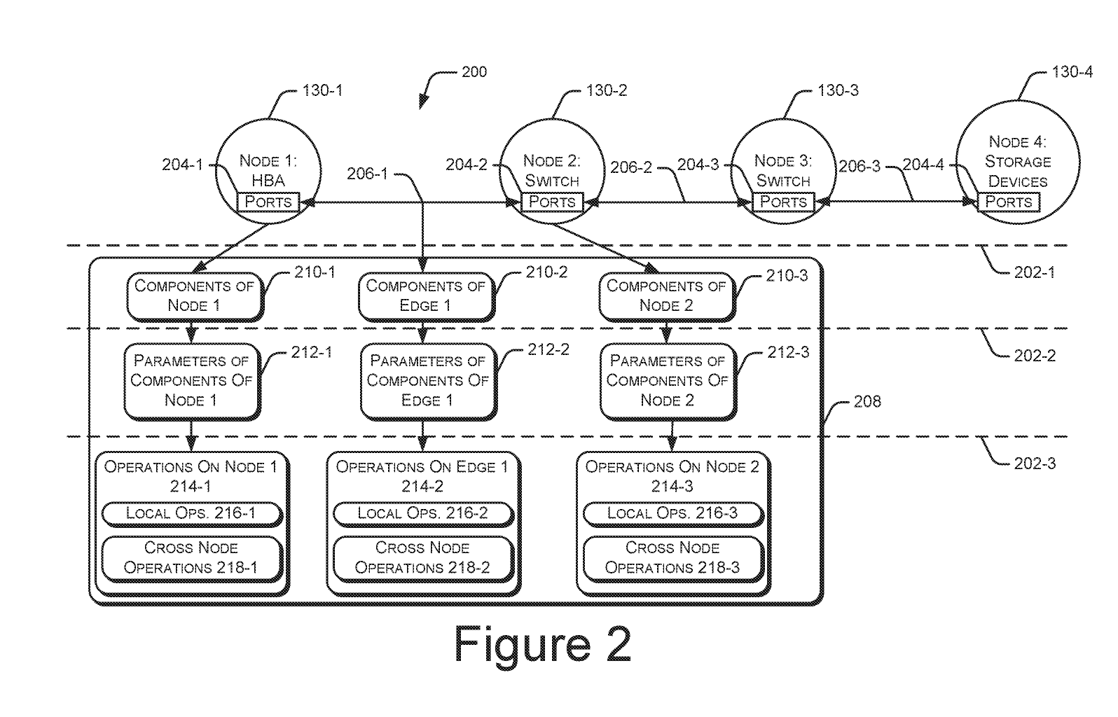

Based on the discovered nodes 130 and edges, the MLNGG module 108 may determine the topology of the SAN 102 and generate a four layered graph depicting the topology of the SAN 102. The generation of the four layered graph is described in detail in conjunction with FIG. 2.

Based on the generated graph, a monitoring module 110 identifies parameters on which the performance of a component of a node or an edge is dependent. An example of such a component is an optical SFP with parameters such as transmitted power, received power, temperature, supply voltage and transmitted bias. In one example, the monitoring module 110 may obtain the readings of the values of the parameters from sensors associated with the component. In another example, the monitoring module 110 may include sensors (not shown in figure) to measure the values of the parameters associated with the components.

In one example, the proactive diagnostics module 112 may obtain data of the monitored parameters from the monitoring module 110. Thereafter, the proactive diagnostics module 112 may smoothen the data. In one example, the proactive diagnostics module 112 may implement moving average or rolling average technique to smoothen the data. In moving average technique, the proactive diagnostics module 112 may break the data obtained from monitoring module 110 into subsets of data. Based on a category of the parameter, the subsets may be created by the proactive diagnostics module 112. For example, for parameters, which are associated with response time of the SAN 102, such as disk read speed, disk write speed, and disk seek speed, the subset size may be 5. Alternatively, for parameters, associated with operating conditions of the SAN 102, such as temperature of the component and power received by the component, the subset size may be larger, such as 10. For the purpose of creation of the subsets, a subset size, indicating a number of values of the monitored data to be included in each of the subsets may be defined by the administrator of the SAN 102, in one example, and stored in the operations and rules data 124. The proactive diagnostics module 112 determines average of the first subset and the same is denoted as the first moving average value. Thereafter, the proactive diagnostics module 112 shifts the subset forward by a pre-defined number of values, denoted by N. In other words, the proactive diagnostics module 112 excludes the first N values of the monitored data of the first subset and includes the next N values of the monitored data to form a new subset. Thereafter, the proactive diagnostics module 112 computes the average of the new subset to determine the second moving average. Based on the moving averages, the proactive diagnostics module 112 smoothens the data associated with the monitoring. Smoothening the data helps in eliminating minor oscillations and noise in the monitored data.

In one example, the proactive diagnostics module 112 may determine trends in the smoothened data, using techniques, such as segmented linear regression. In one example, using segmented linear regression, the PMD system 100 may determine the relationship between a scalar dependent variable, in this case a parameter of a component, and one or more explanatory variables, in this case another parameter(s) of the component or elapsed time period post installation of the component.

In one example, the proactive diagnostics module 112 depicts the relationship between the parameter and the elapsed time as a plot. In said example, the proactive diagnostics module 112 breaks the plot into a plurality of segments of equal segment size. The segment size, used for segmented linear regression, may be varied by the administrator of the SAN based on the parameter of the component and the degradation stage of the component.

In said example, the proactive diagnostics module 112 may implement segmented regression to compute slopes of the segments of the plot. As mentioned earlier, the slopes indicate the rate of change of the values of the monitored parameters with respect to elapsed time. Based on the slope, the proactive diagnostics module 112 determines the hinge in the smoothened data. Thus, the hinge may refer to a connecting point of two data sets which have different trends.

In one example, the proactive diagnostics module 112 may further enhance the precision with which the hinge is determined. In said example, the proactive diagnostics module 112 determines goodness of fit of regression of the segments of the plot. The proactive diagnostics module 112 then identifies segments which have values of goodness of fit lower than a pre-defined threshold. Since, a low value of goodness of fit is associated with consecutive changes in slope, this helps the proactive diagnostics module 112 to determine a precise hinge.

In one example, the proactive diagnostics module 112 may further enhance the accuracy with which the hinge is determined. In said example, the proactive diagnostics module 112 may also filter out data associated with rapid fall or rise in slope in the smoothened data. For example, a power failure or an accidental unplugging and subsequent plugging of a connecting element, such as a cable and a power surge, may cause a steep slope indicating a rise or a fall in the monitored data. In one example, the proactive diagnostics module 112 monitors regression error residual values present in the smoothened data. The regression error residual values are indicative of the extent of a deviation of a value of the monitored parameter from an expected value of the monitored parameter. For example, the expected temperature of a storage device under normal working conditions of the SAN may be 53 degree centigrade, whereas the measured value of the temperature of the storage device is 60 degree centigrade. Herein, the deviation of the expected temperature and the measure temperature indicates the regression error residual value. Toggling of regression error residual values about a normal reference value is indicative of a sudden rise or dip in the value of the monitored parameter. In said example, the proactive diagnostics module 112 filters out data associated with the toggled regression error residual values. Removal of data associated with spikes and data associated with the regression error residual values from the smoothened data enhances the accuracy with which the hinge is determined.

Upon identifying the hinge, the proactive diagnostics module 112 performs proactive diagnostics. The proactive diagnostics involves performing operations associated with the components of the nodes 130 and connecting elements. The operations may be either a local node operation, a cross node operation or a combination of the two based on the topology of the SAN as depicted in the graph. Based on the operations, it may be ascertained that the component, the parameters of which have been monitored by the monitoring module 110, had degraded and accordingly, the rate of degradation of the component and a remaining lifetime of the component may be computed by the proactive diagnostics module 112.

In one example, the proactive diagnostics module 112 determines the rate of degradation of the component based on the rate of change of slope of the smoothened data. The proactive diagnostics module 112 may also determine the remaining lifetime of the component based on the rate of change of slope. In one example, the proactive diagnostics module 112 may normalize the remaining life time of the component based on the time interval elapsed after occurrence of the hinge. For example, rate of degradation of a component from 90% of its expected performance to 80% of its expected performance may be slower or different than the rate of degradation of a component from 60% of its expected performance to 50% of its expected performance. Normalization of the value of remaining lifetime facilitates the proactive diagnostics module 112 to accurately estimate the remaining lifetime of the component. In one example, the proactive diagnostics module 112 may retrieve preexisting statistical information, as the component state data 122, about the stages of degradation of the component to estimate the remaining lifetime.

Based on the remaining lifetime of the component, the proactive diagnostics module 112 may generate notifications in form of alarms and warnings. For example, if the remaining lifetime of the component is below a pre-defined value, such as ‘X’ number of days, the proactive diagnostics module 112 may generate an alarm, In another example, the proactive diagnostics module 112 may generate a warning on identification of the hinge,

The proactive diagnostics module 112 may also perform “what-if” analysis to determine the severity of the impact of the potential failure or potential degradation of the component on the functioning and performance of the SAN. For example, the proactive diagnostics module 112 may determine that if a cable fails, then a portion of the SAN 102 may not be accessible to the computing systems, such as the client devices 128. In another example, if the proactive diagnostics module 112 determines that an optical fiber has started to degrade, then the proactive diagnostics module 112 may determine that the response time of the SAN 102 is likely to increase by 10% over the next twenty four hours based on the rate of degradation of the optical fiber. Thus, the proactive diagnostics module 112 identifies the severity of the degradation based on operations depicted in the fourth layer of the graph. The operations depicted in the fourth layer of the graph are associated with parameters which are depicted in the third layer of the graph. The parameters are in turn associated with components, which are depicted in the second layer of the graph, of nodes and edges depicted in the first layer of the graph. Thus, the operations associated with the fourth layer are linked with the nodes and edges of the first layer depicted in the graph.

Thus, the PMD system 100 informs the administrator about potential degradation and malfunctioning of components of the SAN 102. This helps the administrator in timely replacing the degraded components which ensures continuance in operation of the SAN 102.

FIG. 2 illustrates a graph 200 depicting the topology of a storage area network, such as the SAN 102, for performing proactive diagnostics, according to an example of the present subject matter. In one example, the MLNGG module 114 determines the topology of the SAN 102 and generates the graph 200 depicting the topology of the SAN 102. As mentioned earlier, the device discovery module 118 uses various mechanisms to discover devices, such as switches, HBAs and storage devices, in the SAN and designates the same as nodes 130-1, 130-2, 130-3 and 130-4. Each of the nodes 130-1, 130-2, 130-3 and 130-4 may include ports, such as ports 204-1, 204-2, 204-3 and 204-4, respectively, which facilitates interconnection of the nodes 130. The ports 204-1, 204-2, 204-3 and 204-4 are henceforth collectively referred to as the ports 204 and singularly as the port 204.

The device discovery module 118 may also detect the connecting elements 206-1, 206-2 and 206-3 between the nodes 130 and designate the detected connecting elements 206-1, 206-2 and 206-3 as edges. Examples of the connecting elements 206 include cables and optical fibers. The connecting elements 206-1, 206-2 and 206-3 are henceforth collectively referred to as the connecting elements 206 and singularly as the connecting element.

Based on the discovered nodes 130 and edges 206, the MLNGG module 108 generates a first layer of the graph 200 depicting discovered nodes 130 and edges and the interconnection between the nodes 130 and the edges. In FIG. 2, the portion above the line 202-1 depicts the first layer of the graph 200.

In one example, the second, third and fourth layers of the graph 200 beneath the interconnection of ports of two adjacent nodes 130 are collectively referred to as a Minimal Connectivity Section (MCS) 208. As depicted in FIG. 2, the three layers beneath Nodel 130-1 and Node2 130-2 are the MCS 208. Similarly, the three layers beneath Node2 130-2 and Node3 130-3 is also another MCS (not depicted in figure).

The MLNGG module 108 may then generate the second layer of the graph 200 to depict components of the nodes and the edges. The portion of the graph 200 between the lines 202-1 and 202-2 depicts the second layer. In one example, the MLNGG module 108 discovers the components 210-1 and 210-3 of the Nodel 130-1 and the Node2 130-2 respectively. The components 210-1, 210-2 and 210-3 are collectively referred to as the components 210 and singularly as the component 210.

The MLNGG module 108 also detects the components 210-2 of the edges, such as the edge representing the connecting element 206-1 depicted in the first layer. An example of such components 210 may be cables. In another example, the MLNGG module 108 may retrieve a list of components 210 for each node 130 and edge from a database maintained by the administrator, Thus, the second layer of the graph may also indicate physical connectivity infrastructure of the SAN 102.

Thereafter, the MLNGG module 108 generates the third layer of the graph. The portion of the graph depicted between the lines 202-2 and 202-3 is the third layer. The third layer depicts the parameters of the components of the nodel 212-1, parameters of the components of edgel 212-2, and so on. The parameters of the components of the nodel 212-1 and parameters of the components of edgel 212-2 are parameters indicative of performance of nodel and edgel , respectively. The parameters 212-1, 212-2 and 212-3 are collectively referred to as the parameters 212 and singularly as parameter 212. Examples of parameters 212 may include temperature of the component 212, received power by the component 212, transmitted power by the component 212, attenuation caused by the component 212 and gain of the component 212.

In one example, the MLNGG module 108 determines the parameters 212 on which the performance of the components 210 of the node 130, such as SFP modules, may be dependent on. Examples of such parameters 212 may include received power, transmitted power and gain. Similarly, the parameters 212 on which the performance or the working of the edges 206, such as a cable between two switch ports, is dependent on may be length of the cable and attenuation of the cable.

The MLNGG module 108 also generates the fourth layer of the graph. In FIG. 2, the portion of the graph 200 below the line 202-3 depicts the fourth layer. The fourth layer indicates the operations on nodel 214-1 which may be understood as operations to be performed on the components 210-1 of the nodel 130-1. Similarly operations on edgel 214-2 are operations to be performed on the components 210-2 of the connecting element 206-1 and operations on node2 214-3 are operations to be performed on the components 210-3 of the node2 130-2. The operations 214-1, 214-2 and 214-3 are collectively referred to as the operations 214 and singularly as the operation 214.

As mentioned earlier, the operations 214 may be classified as local node operations 216 and cross node operations 218. The local node operations 216 may be the operations, performed on one of a node 130 and an edge, which affect the working of the node 130 or the edge. The cross node operations 218 may be the operations that are performed based on the parameters of the interconnected nodes, such as the nodes 130-1 and 130-2, as depicted in the first layer of the graph 200. In one example, the operations 216 may be defined for each type of the components 210. For example, local node operations and cross node operations defined for a SFP module may be application to all SFP modules. This facilitates abstraction of the operations 216 from the components 210.

The graph 200 may further facilitate easy identification of the degraded component 210 especially when the degraded component 210 is connected to multiple other components 210. In one example, the proactive diagnostics module 112 may determine that a hinge has occurred in data associated with values of transmitted power in a first component 210, which is connected to multiple other components 210.

In one example, the proactive diagnostics module 112 may perform local node operations to ascertain that the first component has degraded and caused the hinge. For example, the proactive diagnostics module 112 may determine whether parameters, such as gain and attenuation, of the first component have changed and thus, caused the hinge.

Further the proactive diagnostics module 112 may also perform cross node operations. For example, based on the graph, the proactive diagnostics module 112 may determine that a second component 210, which is interconnected with the first component 210, is transmitting less power than expected. Thus, the graph helps in identifying that the second component 210, from amongst the multiple components 210 interconnected with the first component 210, has degraded and has caused the hinge.

In one example, on detecting that the hinge is caused due to an interconnected component, the proactive diagnostics module 112 may compute the remaining lifetime for the interconnected component.

The graph 200 thus depicts the topology of the SAN and shows the interconnection between the nodes 130 and connecting elements 206 along with the one or more operations associated with the components of the nodes 130 and connecting elements 206. In one example, the operations may comprise at least one of a local node operation and a cross node operation based on the topology of the SAN. Thus, the graph 200 facilitates proactive diagnostics of any component of the SAN by identifying operations to be performed on the component.

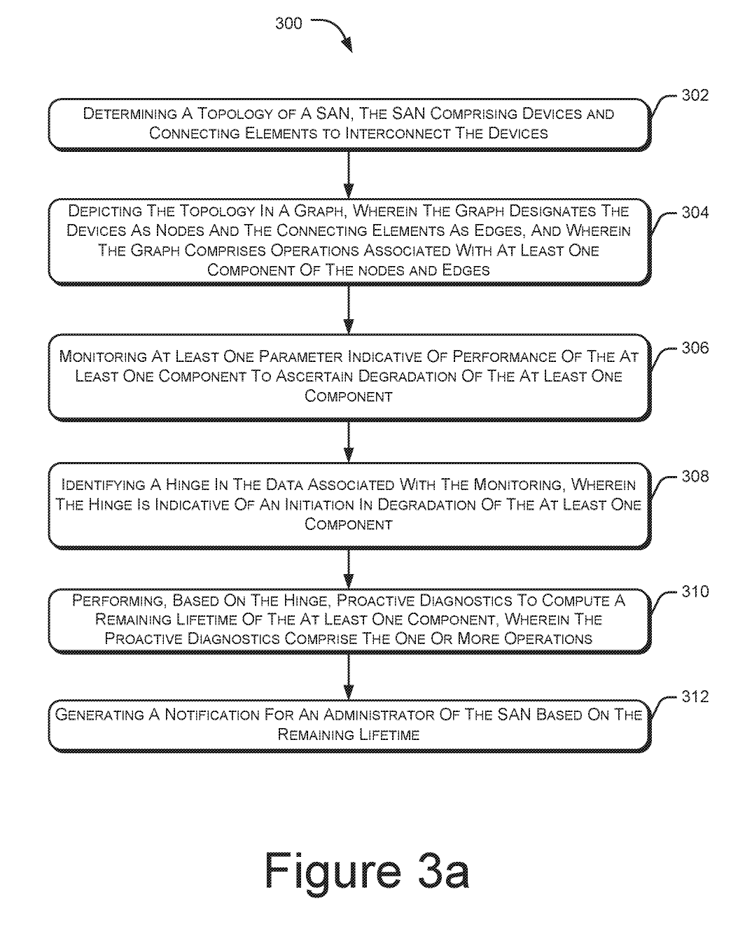

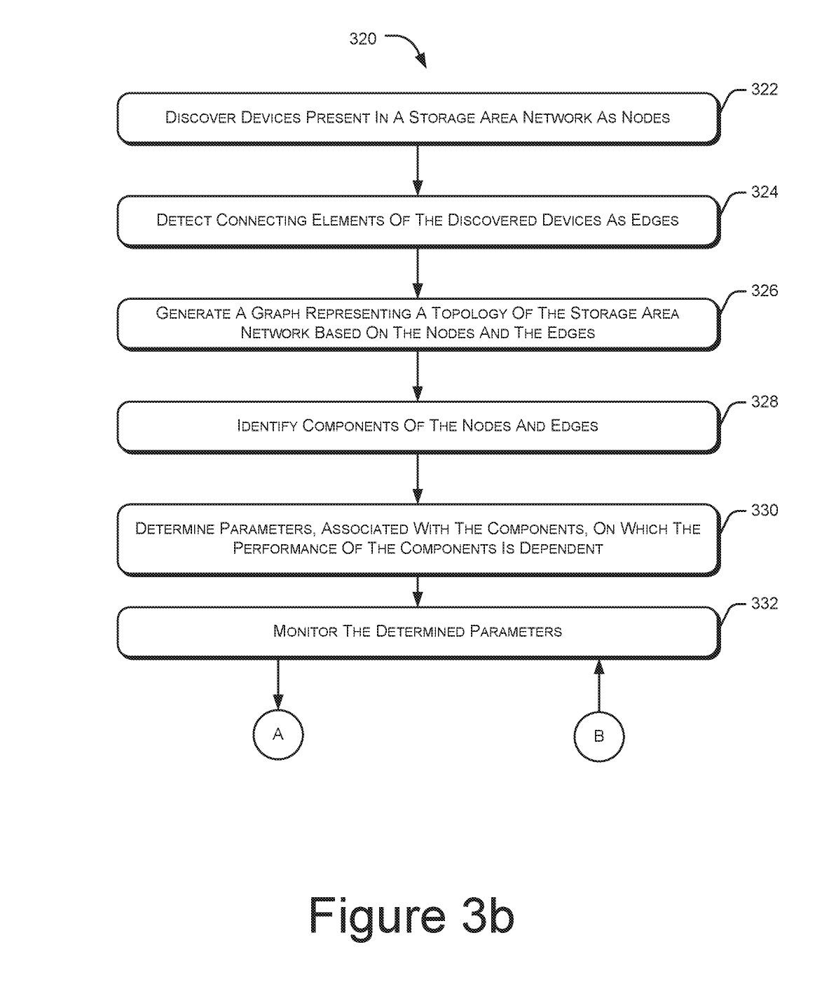

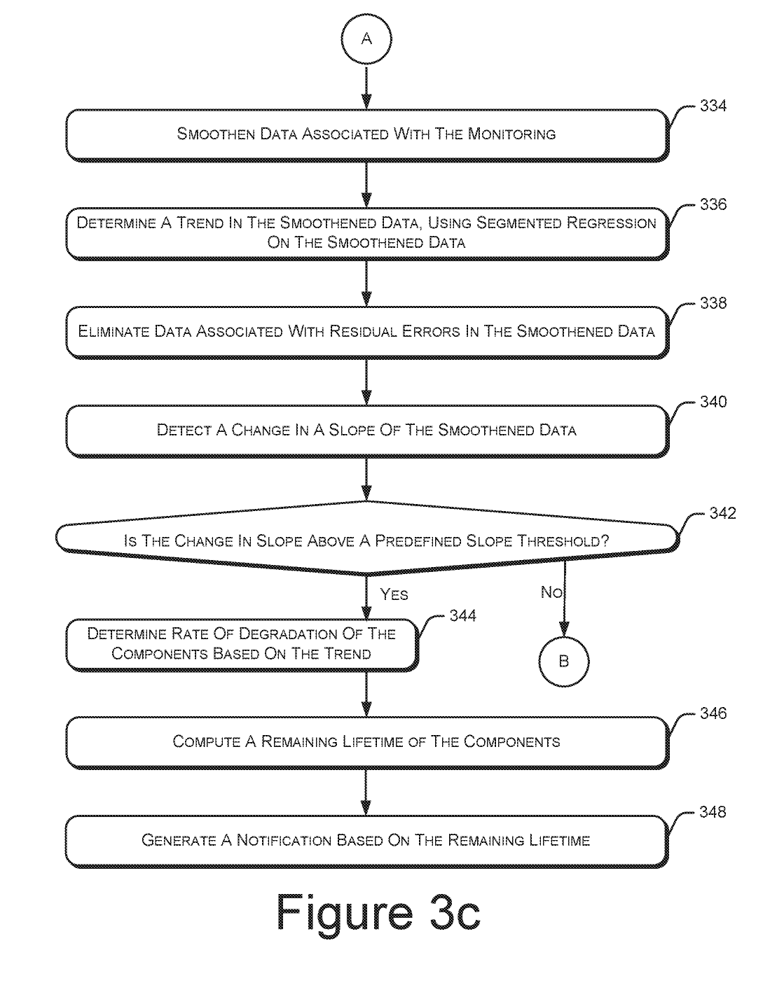

FIGS. 3a and 3b illustrate methods 300 and 320 for proactive monitoring and diagnostics of a storage area network, according to an example of the present subject matter. The order in which the methods 300 and 320 are described is not intended to be construed as a limitation, and any number of the described method blocks can be combined in any order to implement the methods 300 and 320, or an alternative method. Additionally, some individual blocks may be deleted from the methods 300 and 320 without departing from the spirit and scope of the subject matter described herein. Furthermore, the methods 300 and 320 may be implemented in any suitable hardware, computer-readable instructions, or combination thereof.

The steps of the methods 300 and 320 may be performed by either a computing device under the instruction of machine executable instructions stored on a storage media or by dedicated hardware circuits, microcontrollers, or logic circuits. Herein, some examples are also intended to cover program storage devices, for example, digital data storage media, which are machine or computer readable and encode machine-executable or computer-executable programs of instructions, where said instructions perform some or all of the steps of the described methods 300 and 320. The program storage devices may be, for example, digital memories, magnetic storage media, such as a magnetic disks and magnetic tapes, hard drives, or optically readable digital data storage media.

With reference to method 300 as depicted in FIG. 3a, as depicted in block 302, a topology of the storage area network (SAN) 102 is determined. As mentioned earlier, the SAN 102 comprises devices and connecting elements to interconnect the devices. In one implementation, the MLNGG module 108 determines the topology of the SAN 102.

As shown in block 304, the topology of the SAN 102 is depicted in form of a graph. The graph is generated by designating the devices as nodes 130 and connecting elements 206 as edges. The graph further comprises operations associated with at least one component of the nodes and edges. In one example, the monitoring module 110 generates the graph 200 depicting the topology of the SAN 102.

At block 306, at least one parameter, indicative of performance of at least one component, is monitored to ascertain degradation of the at least one component. The at least one component may be of a device or a connecting element. In one example, the monitoring module 110 may monitor the at least one parameter, indicative of performance of at least one component, by measuring the values of the at least one parameter or reading the values of the at least one parameter from sensors associated with the at least one component. Examples of such parameters include received power, transmitted power, supply voltage, temperature, and attenuation.

As depicted in block 308, a hinge in the data associated with the monitoring is identified, The hinge is indicative of an initiation in degradation of the at least one component. In one example, the proactive diagnostics module 112 identifies the hinge in the data associated with the monitoring.

As illustrated in block 310, based on the hinge, proactive diagnostics is preformed to identify the at least one component which has degraded and compute a remaining lifetime of the at least one component, wherein the proactive diagnostics comprise the one or more operations. In one example, the proactive diagnostics module 112 performs proactive diagnostics to compute a remaining lifetime of the at least one component. In one example, the proactive diagnostics module 112 may also determine the remaining lifetime of the component based on the rate of degradation of the component. The proactive diagnostics module 112 may further normalize the remaining lifetime of the component based on the time interval elapsed after occurrence of the hinge. Normalization of the value of remaining lifetime facilitates the proactive diagnostics module 112 to accurately estimate the remaining lifetime of the component and reduce the effect of variance of the rate of degradation of the component. In one example, the proactive diagnostics module 112 may retrieve statistical information about the stages of degradation of the component to estimate the remaining lifetime.

As shown in block 312, a notification is generated based on the remaining lifetime. In one example, based on the remaining lifetime of the component, the proactive diagnostics module 112 may generate notifications in form of alarms and warnings. For example, if the remaining lifetime of the component is below a pre-defined value, such as ‘X’ number of days, the proactive diagnostics module 112 may generate an alarm.

FIGS. 3b and 3c illustrate a method 320 for a method for proactive monitoring and diagnostics of a storage area network, according to another example of the present subject matter. With reference to method 320 as depicted in FIG. 3b, at block 322, the devices present in a storage area network are discovered and designated as nodes. In one example, the device discovery module 118 may discover the devices present in a storage area network and designate them as nodes.

As illustrated in block 324, the connecting elements of the discovered devices are detected as edges. In one example, the device discovery module 118 may discover the connecting elements, such as cables, of the discovered devices. In said example, the connecting elements are designated as edges.

As shown in block 326, a graph representing a topology of the storage area network is generated based on the nodes and the edges. In one example, the MLNGG module 108 generates a four layered graph depicting the topology of the SAN based on the detected nodes and edges.

At block 328, components of the nodes and edges are identified. In one example, the monitoring module 110 may identify the components of the nodes 130 and edges 206. Examples of components of nodes 130 may include ports, sockets, cooling unit and magnetic heads.

At block 330, the parameters, associated with the components, on which the performance of the components is dependent, are determined. In one example, the monitoring module 110 may identify the parameters based on which the performance of a component is dependent. Examples of such parameters include received power, transmitted power, supply voltage, temperature, and attenuation.

As illustrated in block 332, the determined parameters are monitored. In one example, the monitoring module 110 may monitor the determined parameters by measuring the values of the determined parameters or reading the values of parameters from sensors associated with the components. The monitoring module 110 may monitor the determined parameters either continuously or at regular time intervals, for example every three hundred seconds.

The remaining steps of the method are depicted in FIG. 3c. With reference to method 320 as depicted in FIG. 3c, at block 334, the data obtained from monitoring of the parameters is smoothened. In one example, the proactive diagnostics module 112 may smoothen the data using techniques such as the moving average technique.

As shown in block 336, segmented regression is performed on the smoothened data to determine a trend in the smoothened data. In one example, the proactive diagnostics module 112 may perform segmented linear regression on the smoothed data to determine the trend of the smoothened data. The proactive diagnostics module 112 may select a segment size based on the parameter whose values are being monitored.

As illustrated in block 338, noise, i.e., the data associated with regression residual errors in the smoothened data are eliminated. In one example, the proactive diagnostics module 112 may eliminate the noise, i.e. the data that causes spikes and is not indicative of degradation in the component.

At block 340, a change in a slope of the smoothened data is detected. In one example, the proactive diagnostics module 112 monitors the value of slope for detecting change in the slope of the smoothened data.

At block 342, it is determined whether the change in the slope exceeds a pre-defined slope threshold. In one example, the proactive diagnostics module 112 determines whether the change in the slope exceeds pre-defined slope threshold.

If at block 342, the change in the slope does not exceed a pre-defined slope threshold, then, as shown in block 332, the monitoring module 110 continues monitoring the determined parameters of the component.

If at block 342, the change in the slope exceeds a pre-defined slope threshold, then, as shown in block 344, the proactive diagnosis is initiated and the rate of degradation of the component is computed based on the trend. In one example, the proactive diagnostics module 112 determines the rate of degradation of the component based on the trend of the smoothened data.

As depicted in block 346, a remaining lifetime of the components is computed. The remaining lifetime is the time interval in which the components may fail or malfunction or fully degrade. In one example, the proactive diagnostics module 112 may also determine the remaining lifetime of the component based on the rate of degradation of the component. The proactive diagnostics module 112 may further normalize the remaining life time of the component based on the time interval elapsed after occurrence of the hinge. Normalization of the value of remaining lifetime facilitates the proactive diagnostics module 112 to accurately estimate the remaining lifetime of the component and reduce the effect of variance of the rate of degradation of the component. In one example, the proactive diagnostics module 112 may retrieve statistical information about the stages of degradation of the component to estimate the remaining lifetime.

As shown in block 348, a notification is generated based on the remaining lifetime. In one example, based on the remaining lifetime of the component, the proactive diagnostics module 112 may generate notifications in form of alarms and warnings. For example, if the remaining lifetime of the component is below a pre-defined value, such as ‘X number of days, the proactive diagnostics module 112 may generate an alarm. The proactive diagnostics module 112 may also perform “what-if” analysis to determine the impact of the potential failure or potential degradation of the component on the functioning and performance of the SAN 102.

Thus, the methods 300 and 320, informs the administrator about potential degradation and malfunctioning of components of the SAN 102. This helps the administrator in timely replacing the degraded components which helps in the continuance in operation of the SAN 102.

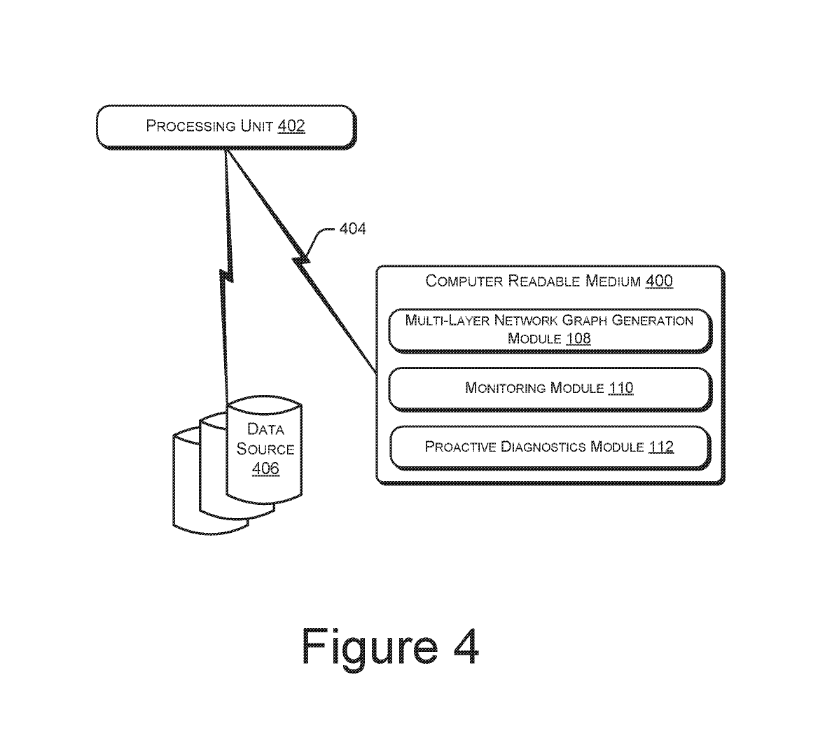

FIG. 4 illustrates a computer readable medium 400 storing instructions for proactive monitoring and diagnostics of a storage area network, according to an example of the present subject matter. In one example, the computer readable medium 400 is communicatively coupled to a processing unit 402 over communication link 404.

For example, the processing unit 402 can be a computing device, such as a server, a laptop, a desktop, a mobile device, and the like. The computer readable medium 400 can be, for example, an internal memory device or an external memory device, or any commercially available non transitory computer readable medium. In one implementation, the communication link 404 may be a direct communication link, such as any memory read/write interface. In another implementation, the communication link 404 may be an indirect communication link, such as a network interface, In such a case, the processing unit 402 can access the computer readable medium 400 through a network.

The processing unit 402 and the computer readable medium 400 may also be communicatively coupled to data sources 406 over the network. The data sources 406 can include, for example, databases and computing devices. The data sources 406 may be used by the requesters and the agents to communicate with the processing unit 402.

In one implementation, the computer readable medium 400 includes a set of computer readable instructions, such as the MLNGG module 108, the monitoring module 110 and the proactive diagnostics module 112. The set of computer readable instructions can be accessed by the processing unit 402 through the communication link 404 and subsequently executed to perform acts for proactive monitoring and diagnostics of a storage area network.

On execution by the processing unit 402, the M NGG module 108 generates a graph representing a topology of the SAN 102. The graph comprising nodes indicative of devices in the SAN, edges indicative of connecting elements between the devices, and one or more operations associated with at least one component of the nodes 130 and edges.

Thereafter, the monitoring module 110 monitors at least one parameter indicative of performance of the at least one component to determine a degradation in the performance of the at least one component. In one example, the proactive diagnostics module 112 may apply averaging techniques to smoothen data associated with the monitoring and determine a trend in the smoothened data.

The proactive diagnostics module 112 further applies segmented linear regression on the smoothened data for identifying a hinge in the smoothened data, wherein the hinge is indicative of an initiation in degradation of the at least one component. Based on the hinge and the trend in the smoothened data, the proactive diagnostics module 112 determines a remaining lifetime of the at least one component on based on the hinge. Thereafter, the proactive diagnostics module 112 generates a notification for an administrator of the SAN based on the remaining lifetime.

Although implementations for proactive monitoring and diagnostics of a storage area network have been described in language specific to structural features and/or methods, it is to be understood that the appended claims are not necessarily limited to the specific features or methods described. Rather, the specific features and methods are disclosed as examples of systems and methods for proactive monitoring and diagnostics of a storage area network.

I/We claim:

1. A system for proactive monitoring and diagnostics of a storage area network (SAN), comprising:
a processor ; and
a multi-layer network graph generation (MLNGG) module, coupled to the processor, to generate a graph representing a topology of the SAN, the graph comprising nodes indicative of devices in the SAN, edges indicative of connecting elements between the devices, and one or more operations associated with at least one component of the nodes and edges;
a monitoring module, coupled to the processor, to:
monitor at least one parameter indicative of performance of the at least one component; and
a proactive diagnostics module, coupled to the processor, to:
determine a trend in data associated with the monitoring for identifying a hinge in the data, wherein the hinge is indicative of an initiation in degradation of the at least one component; and
perform proactive diagnostics based on the hinge, wherein
the proactive diagnostics comprise the one or more operations.

2. The system of claim 1, wherein the proactive diagnostics module further to:
determine a remaining lifetime of the at least one component based on the hinge and the trend in the data associated with the monitoring; and
generate a notification for an administrator of the SAN based on the remaining lifetime.

3. The system of claim 1, wherein the MLNGG module further to: identify the nodes and the edges in the SAN to create a first layer of the graph;
determine components of the nodes and the edges to create a second layer of the graph;
ascertain parameters of the components to create a third layer of the graph, wherein the parameters are associated with performance of the components; and
identify the operations to be performed on the nodes and edges to create a fourth layer of the graph.

4. The system of claim 1 further comprising a device discovery module, coupled to the processor (104), to:
discover the devices present in the SAN; and
discover the connecting elements between the devices in the SAN.

5. The system of claim 1, wherein the proactive diagnostics module further to:
apply averaging techniques to smoothen the data associated with the monitoring; and
apply segmented linear regression on the smoothened data to determine the hinge.

6. The system of claim 5, wherein the proactive diagnostics module further substantially to eliminate data associated with regression error residual values, based on the segmented linear regression, to determine the hinge.

7. The system of claim 5, wherein the proactive diagnostics module further to:
determine a change in slope of the smoothened data;
ascertain whether the change in slope exceeds a pre-defined slope threshold; and
identify the hinge on ascertaining the change in slope to exceed the pre-defined slope threshold.

8. A method for proactive monitoring and diagnostics of a storage area network (SAN), the method comprising:
determining a topology of the SAN, the SAN comprising devices and connecting elements to interconnect the devices;
depicting the topology in a graph, wherein the graph designates the devices as nodes and the connecting elements as edges, and wherein the graph comprises operations associated with at least one component of the nodes and edges;
monitoring at least one parameter indicative of performance of the at least one component to ascertain degradation of the at least one component;
identifying, a hinge in the data associated with the monitoring, wherein the hinge is indicative of an initiation in degradation of the at least one component;
performing, based on the hinge, proactive diagnostics to compute a remaining lifetime of the at least one component, wherein the proactive diagnostics comprise the one or more operations; and
generating a notification of the SAN based on the remaining lifetime.

9. The method of claim 8, wherein the depicting further comprises:
identifying the nodes and the edges in the SAN to create a first layer of the graph;
determining components of the nodes and the edges to create a second layer of the graph;
ascertaining parameters of the components to create a third layer of the graph, wherein the parameters are associated with performance of the components and
identifying the operations to be performed on the nodes and edges to create a fourth layer of the graph.

10. The method of claim 8, further comprising:
determining whether the hinge is caused due to an interconnected component of the at least one component; and
computing a remaining lifetime for the interconnected component on determining the hinge to have been caused due to the interconnected component.

11. The method of claim 8, wherein identifying the hinge further comprises substantially smoothening the data associated with the monitoring, based on moving average technique.

12. The method of claim 11, wherein identifying the hinge further comprises:
determining a change in slope of the smoothened data;
ascertaining whether the change in slope exceeds a pre-defined slope threshold; and
identifying the hinge on ascertaining the change in slope to exceed the pre-defined slope threshold.

13. The method of claim 11, wherein identifying the hinge further comprises:
applying segmented linear regression on the smoothened data; and
substantially eliminating the data associated with regression error residual values, based on the segmented linear regression, to determine the hinge.

14. A non-transitory computer-readable medium having a set of computer readable instructions that, when executed, cause a proactive monitoring and diagnostics system to:
generate a graph representing a topology of a storage area network (SAN), the graph comprising nodes indicative of devices in the SAN, edges indicative of connecting elements between the devices_{;} and one or more operations associated with at least one component of the nodes and edges;
monitor at least one parameter indicative of performance of the at least one component to determine a degradation in the performance of the at least one component;
apply averaging techniques to smoothen data associated with the monitoring;
determine a trend in the smoothened data;
apply segmented linear regression on the smoothened data for identifying a hinge in the smoothened data, wherein the hinge is indicative of an initiation in degradation of the at least one component;
determine a remaining lifetime of the at least one component on based on the hinge and the trend in the smoothened data; and
generate a notification of the SAN based on the remaining lifetime.

15. The non-transitory computer-readable medium of claim 14, wherein execution of the set of computer readable instructions further cause the proactive monitoring and diagnostics system to:
identify the nodes and the edges in the SAN to create a first layer of the graph;
determine components of the nodes and the edges to create a second layer of the graph;
ascertain parameters of the components to create a third layer of the graph, wherein the parameters are associated with performance of the components ; and
identify the one or more operations to be performed on the nodes and edges to create a fourth layer of the graph.
